(19) United States
(12) Patent Application Publication
(10) Pub. No.: US 2014/0067492 A1
(43) Pub. Date: Mar. 6, 2014

(54) SYSTEM FOR PARKING PAYMENT USING A MOBILE DEVICE

(71) Applicant: Optimization Technologies, Inc., Portland, OR (US)

(72) Inventor: Dexter Turner, West Linn, OR (US)

(73) Assignee: Optimization Technologies, Inc., Portland, OR (US)

(21) Appl. No.: 14/047,842

(22) Filed: Oct. 7, 2013

Related U.S. Application Data
(63) Continuation-in-part of application No. 14/014,108, filed on Aug. 29, 2013.
(60) Provisional application No. 61/710,643, filed on Oct. 5, 2012.
(60) Provisional application No. 61/694,647, filed on Aug. 29, 2012.

(51) Int. Cl. G06Q 20/14; G06Q 20/32

(52) U.S. Cl. CPC G06Q 20/145; G06Q 20/322
USPC 705/13

(57) ABSTRACT

Disclosed below are representative embodiments of methods, apparatus, and systems relating to a mobile device payment system for parking payment kiosks (“PPKs”). Among the example embodiments disclosed herein are parking payment kiosks that use mobile devices for payment. Embodiments of the disclosed technology can be used to improve the basic parking process by reducing the amount of time that the driver has to interact with the kiosk. Embodiments of the disclosed technology can also be used to minimize the labor required by parking enforcement. Embodiments of the disclosed technology comprise an access control and payment system that uses a customer's internet-connected mobile device and a display apparatus on the PPK.

### CROSS REFERENCE TO RELATED APPLICATION

This application claims the benefit of U.S. Provisional Application No. 61/710,643 filed on Oct. 5, 2012, and entitled “SYSTEM FOR PARKING PAYMENT USING A MOBILE DEVICE,” which is hereby incorporated herein by reference.

This application is also a continuation-in-part of U.S. Nonprovisional application Ser. No. 14/014,108, filed on Aug. 29, 2013 and entitled “ELECTRIC VEHICLE CHARGING STATION MOBILE DEVICE PAYMENT SYSTEM”, which claims the benefit of U.S. Provisional Application No. 61/694,647, filed on Aug. 29, 2012, and entitled “ELECTRIC VEHICLE CHARGING STATION MOBILE DEVICE PAYMENT SYSTEM”, both of which are hereby incorporated herein by reference.

### FIELD

This application relates to parking payment kiosks and associated systems.

### SUMMARY

Disclosed below are representative embodiments of methods, apparatus, and systems relating to a mobile device payment system for parking payment kiosks (“PPKs”). The disclosed methods, apparatus, and systems should not be construed as limiting in any way. Instead, the present disclosure is directed toward all novel and nonobvious features and aspects of the various disclosed embodiments, alone and in various combinations and subcombinations with one another. The disclosed methods, apparatus, and systems are not limited to any specific aspect or feature or combination thereof, nor do the disclosed embodiments require that any one or more specific advantages be present or problems be solved. Furthermore, any features or aspects of the disclosed embodiments can be used in various combinations and subcombinations with one another.

Among the embodiments disclosed herein are parking payment kiosks that use mobile devices for payment. Embodiments of the disclosed technology can be used to improve the basic parking process by reducing the amount of time that the driver has to interact with the kiosk. Embodiments of the disclosed technology can also be used to minimize the labor required by parking enforcement. Embodiments of the disclosed technology comprise an access control and payment system that uses a customer's internet-connected mobile device and a display apparatus on the PPK.

Embodiments of the system are built around a mobile device application (also referred to as an “app”) running on the user's internet-connected mobile device. In particular embodiments, the following components comprise the system:
An application running on the user's/driver's internet-connected mobile device that includes a login feature that can uniquely identify the user (this application will be referred to as the parking mobile payment app (“MPA”));
A PPK that includes internet connectivity;
A display apparatus on the PPK that displays either a Quick Response (“QR”) Code, bar code, alpha-numeric code, or some other code that can be read by the MPA; and
A back-office software system that allows users to create accounts that are linked to their credit card or debit card or a bank account for the purpose of paying for parking.

Embodiments of the disclosed systems and methods can be implemented using computing hardware, such as a computer processor embedded in the PPK and/or a mobile computing device. For example, embodiments of the disclosed methods can be performed using software stored on one or more non-transitory computer-readable media (e.g., one or more optical media discs, volatile memory components (such as DRAM or SRAM), or nonvolatile memory or storage components (such as hard drives)). Such software can be executed by a computer processor embedded in the PPK, a computer processor in a mobile device (such as a smart phone, tablet computer, or the like), or by one or more computers coupled to the PPK by a network (e.g., via the internet, a wide-area network, a local-area network, a client-server network, or other such network). Embodiments of the disclosed methods can also be performed by specialized computing hardware (e.g., one or more application specific integrated circuits (“ASICs”) or programmable logic devices (such as field programmable gate arrays (“FPGAs”)) configured to perform any of the disclosed methods). Additionally, any intermediate or final result created or modified using any of the disclosed methods can be stored on a non-transitory storage medium (e.g., one or more optical media discs, volatile memory or storage components (such as DRAM or SRAM), or nonvolatile memory or storage components (such as hard drives)). Furthermore, any of the software embodiments (comprising, for example, computer-executable instructions which when executed by a computer cause the computer to perform any of the disclosed methods) or results (either intermediate or final) created or modified by the disclosed methods can be transmitted, received, or accessed through a suitable communication means.

One exemplary embodiment is a method comprising displaying a parking session code (e.g., a QR code, barcode, alpha-numeric, or other code) on a display apparatus of a parking payment kiosk (“PPK”) and reading this code with a mobile payment application running on an internet-connected mobile device.

Another exemplary embodiment comprises one or more computer-readable media storing computer-executable instructions which when executed by a computer cause the computer to cause the display of a parking session code (e.g., a QR code, barcode, alpha-numeric or other code) on a touch screen of a PPK and one or more computer-readable media storing computer-executable instructions which when executed by an internet-connected mobile device cause the mobile device to read the parking session code and interact with a remote server to transmit this code and the user's personal and vehicle data.

Another exemplary embodiment is a method comprising receiving data from a user's MPA, the data identifying a user, the user's vehicle, and a unique parking session at the parking facility; and, using computing hardware, accessing account data associated with the user, accessing control policies and pricing data associated with the particular parking facility, and using the combination of this data to determine if the user is authorized to complete a parking session at this facility. A related embodiment comprises one or more computer-readable media storing computer-executable instructions which when executed by a computer cause the computer to perform this method.

The foregoing and other objects, features, and advantages of the disclosed technology will become more apparent from the following detailed description, which proceeds with reference to the accompanying figures.

### BRIEF DESCRIPTION OF THE DRAWINGS

FIG. 1 is a schematic block diagram illustrating an exemplary parking payment kiosk with a display device coupled to a back office serve via a network.

FIG. 2 is a schematic block diagram illustrating an exemplary PPK system and the users of the exemplary system.

FIG. 3 is a flowchart of an exemplary method for using a mobile device for parking payment according to an embodiment of the disclosed technology.

FIG. 4 illustrates an exemplary PPK screen showing a possible screen for identifying which payment method the parking user wishes to use.

FIG. 5 is a schematic block diagram of an exemplary computing environment for implementing embodiments of the disclosed technology.

FIG. 6 is a schematic block diagram of an exemplary network communication environment for implementing embodiments of the disclosed technology.

FIG. 7 illustrates an exemplary EVCS/EVSE screen showing a possible screen for presenting the user with a QR code to be scanned by the user in order to authorize a parking session.

### DETAILED DESCRIPTION

### I. General Considerations

Disclosed below are representative embodiments of methods, apparatus, and systems for using and operating parking payment kiosks (“PPKs”) with mobile device payment technology. The disclosed methods, apparatus, and systems should not be construed as limiting in any way. Instead, the present disclosure is directed toward all novel and nonobvious features and aspects of the various disclosed embodiments, alone and in various combinations and subcombinations with one another. Furthermore, any features or aspects of the disclosed embodiments can be used in various combinations and subcombinations with one another. The disclosed methods, apparatus, and systems are not limited to any specific aspect or feature or combination thereof, nor do the disclosed embodiments require that any one or more specific advantages be present or problems be solved.

Although the operations of some of the disclosed methods are described in a particular, sequential order for convenient presentation, it should be understood that this manner of description encompasses rearrangement, unless a particular ordering is required by specific language set forth below. For example, operations described sequentially may in some cases be rearranged or performed concurrently. Moreover, for the sake of simplicity, the attached figures may not show the various ways in which the disclosed methods can be used in conjunction with other methods. Additionally, the description sometimes uses terms like “determine” and “receive” to describe the disclosed methods. These terms are high-level abstractions of the actual operations that are performed. The actual operations that correspond to these terms may vary depending on the particular implementation and are readily discernible by one of ordinary skill in the art. Furthermore, as used herein, the term “and/or” means any one item or combination of items in the phrase.

Any of the disclosed methods can be implemented using computer-executable instructions stored on one or more computer-readable media (e.g., non-transitory computer-readable media, such as one or more optical media discs, volatile memory components (e.g., DRAM or SRAM), or nonvolatile memory or storage components (e.g., hard drives)) and executed on a computer (e.g., any commercially available computer, a computer processor embedded in the PPK, or a computer processor of a mobile device). Any of the intermediate or final data created and used during implementation of the disclosed methods or systems can also be stored on one or more computer-readable media (e.g., non-transitory computer-readable media).

For clarity, only certain selected aspects of the software-based embodiments are described. Other details that are well known in the art are omitted. For example, it should be understood that the software-based embodiments are not limited to any specific computer language or program. For instance, embodiments of the disclosed technology can be implemented by software written in C++, C#, Objective C, Java, Perl, JavaScript, Adobe Flash, or any other suitable programming language Likewise, embodiments of the disclosed technology are not limited to any particular computer or type of hardware. Details of suitable computers and hardware are well known and need not be set forth in detail in this disclosure.

Furthermore, any of the software-based embodiments (comprising, for example, computer-executable instructions stored on a non-transitory computer-readable medium) can be uploaded, downloaded, or remotely accessed through a suitable communication means. Such suitable communication means include, for example, the internet, the World Wide Web, an intranet, cable (including fiber optic cable), magnetic communications, electromagnetic communications (including RF, microwave, and infrared communications), electronic communications, or other such communication means.

The disclosed methods can also be implemented using specialized computing hardware that is configured to perform any of the disclosed methods. For example, the disclosed methods can be implemented by an integrated circuit (e.g., an application specific integrated circuit (“ASIC”) or programmable logic device (“PLD”), such as a field programmable gate array (“FPGA”)) specially designed to implement any of the disclosed methods. The integrated circuit or specialized computing hardware can be embedded in or directly coupled to a PPK or device that is configured to interact with the PPK.

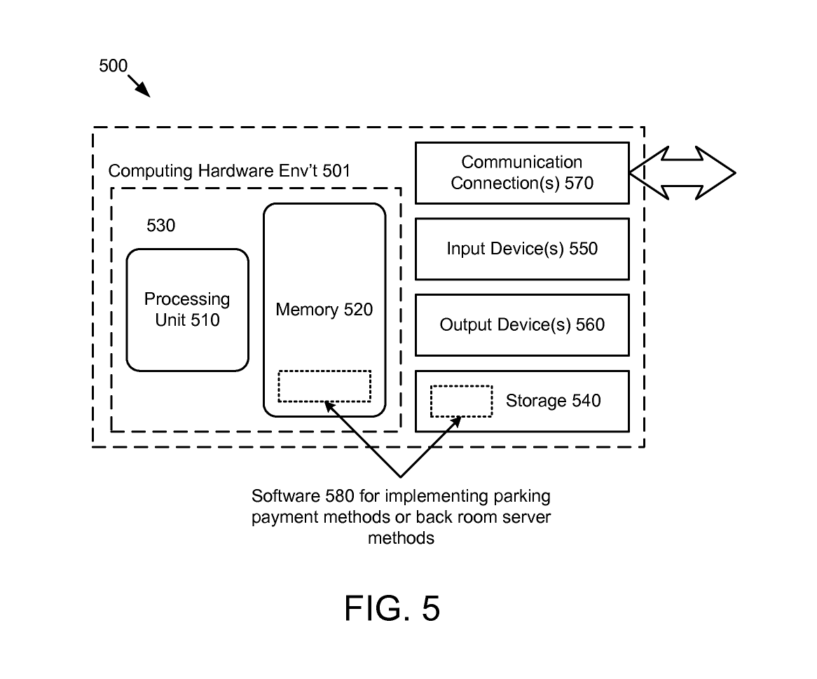

FIG. 5 is a schematic block diagram 500 that illustrates a generalized example of a suitable computing hardware environment 501 in which embodiments of the disclosed technology can be implemented. The computing hardware environment 501 is not intended to suggest any limitation as to the scope of use or functionality of the disclosed technology, as the technology can be implemented in diverse general-purpose or special-purpose computing environments.

With reference to FIG. 5, the computing hardware environment 501 includes at least one processing unit 510 and memory 520. In FIG. 5, this most basic configuration 530 is included within a dashed line. The processing unit 510 executes computer-executable instructions and may be a real or a virtual processor. In a multi-processing system, multiple processing units execute computer-executable instructions to increase processing power. The memory 520 may be volatile memory (e.g., registers, cache, RAM, DRAM, SRAM), non-volatile memory (e.g., ROM, EEPROM, flash memory), or some combination of the two. The memory 520 can store software 580 for implementing one or more of the described techniques for operating or using the disclosed parking payment control systems. For example, the memory 520 can store software 580 for implementing any of the disclosed methods and their accompanying user interfaces.

The computing hardware environment can have additional features. For example, the computing hardware environment 501 includes storage 540, one or more input devices 550, one or more output devices 560, and one or more communication connections 570. An interconnection mechanism (not shown) such as a bus, controller, or network interconnects the components of the computing hardware environment 501. Typically, operating system software (not shown) provides an operating environment for other software executing in the computing hardware environment 501, and coordinates activities of the components of the computing hardware environment 501.

Storage 540 is a type non-volatile memory and can be removable or non-removable. The storage 540 includes, for instance, magnetic disks (e.g., hard drives), magnetic tapes or cassettes, optical storage media (e.g., CD-ROMs or DVDs), or any other tangible non-transitory storage medium which can be used to store information and which can be accessed within or by the computing hardware environment 501. The storage 540 can store the software 580 for implementing any of the described techniques, systems, or environments.

The input device(s) 550 can be a touch input device such as a keyboard, mouse, touch screen, pen, trackball, a voice input device, a scanning device, or another device that provides input to the computing environment 501. The output device(s) 560 can be a display, touch screen, printer, speaker, or another device that provides output from the computing environment 501.

The communication connection(s) 570 enable communication over a communication medium to another computing entity. The communication medium conveys information such as computer-executable instructions, any of the intermediate or final messages or data used in implementing embodiments of the disclosed technology, or other data in a modulated data signal. A modulated data signal is a signal that has one or more of its characteristics set or changed in such a manner as to encode information in the signal. By way of example, and not limitation, communication media include wired or wireless techniques implemented with an electrical, optical, RF, infrared, acoustic, or other carrier. For example, the communication connection(s) 570 can communicate with another computing entity over a wired or wireless network (e.g., the internet, a wide-area network, a local-area network, a Wi-Fi network, a client-server network, a wireless mesh network, or other such network or any combination thereof).

Many of the methods, systems, and interfaces disclosed herein can be described in the general context of computer-executable instructions stored on one or more computer-readable media. Computer-readable media are any available media that can be accessed within or by a computing environment. By way of example, and not limitation, with the computing hardware environment 501, computer-readable media include tangible non-transitory computer-readable media such as memory 520 and storage 540 and do not encompass transitory carrier waves or signals. The various methods, systems, and interfaces disclosed herein can also be described in the general context of computer-executable instructions, such as those included in program modules, being executed in a computing environment on a target real or virtual processor. Generally, program modules include routines, programs, libraries, objects, classes, components, data structures, and the like that perform particular tasks or implement particular abstract data types. The functionality of the program modules may be combined or split between program modules as desired in various embodiments. Computer-executable instructions for program modules may be executed within a local or distributed computing environment.

### II. Exemplary Embodiments of the Disclosed Technology

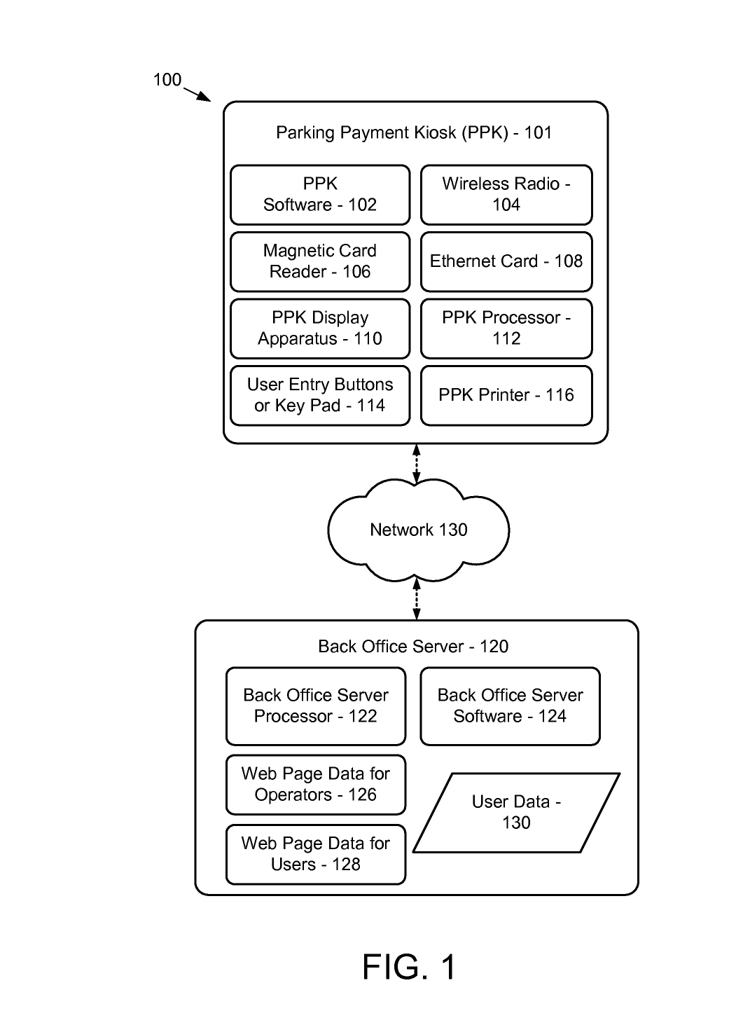

FIG. 1 is a schematic block diagram 100 illustrating a parking payment kiosk (“PPK”) computing hardware environment 101 for implementing embodiments of the disclosed technology. In particular, FIG. 1 illustrates an exemplary computing hardware environment 101 for a PPK and an exemplary computing hardware environment 120 for a back office server. The PPK environment 101 is more specialized than computing hardware environment 501 but should not be construed as limiting the types of hardware that can be used to implement the disclosed technology. The PPK environment 101 and the exemplary computing hardware environment 120 for the back office server can include any of the components described above with respect to the general computing hardware environment 501.

The PPK computing hardware environment 101 includes software 102, which comprises computer-executable instructions stored on non-transitory computer-readable media (e.g., any one or more of the non-transitory computer-readable media described above). When executed, the software can be used to implement the functionality of the PPK which is described in more detail below. The PPK computing hardware environment 101 further comprises a processor 112 for executing the software 102. Suitable processors and associated parts can be obtained, for example, from Parvus Corporation. The PPK computing hardware environment 101 can also include a wireless radio 104 (or other network adapter, such as a cellular transceiver) to provide the environment 101 with a network interface capability for exchanging data with, for example, a back office server 120. Suitable wireless radios and associated parts can be obtained, for example, from Digi International. In the illustrated embodiment, the PPK processor 112 includes Ethernet functionality (shown generally as Ethernet 108 and may comprise an Ethernet card or suitable circuitry for implementing an Ethernet connection) but can include other network functionality. The PPK computing hardware environment 101 also includes a magnetic card reader 106, and a display apparatus 110, such as a touch screen device (e.g., an LCD device). The optional touch screen interface can be a resistive touch screen, a surface acoustic wave touch screen, a capacitive touch screen, infrared touch screen, optical imaging touch screen, dispersive signal touch screen, acoustic pulse recognition touch screen, or any other touch screen that enables position detection of user interaction with the display device. Another possible option to facilitate user interaction is a set of user entry buttons or a keypad 114. Although the exemplary PPK computing hardware environment 101 is shown as including both a touch screen 110 and a set of user entry buttons or keypad 114, the touch screen 110 can be implemented alone or the set of user entry button or keypad 114 can be implemented alone. Suitable magnetic card readers and associated parts can be obtained, for example, from ID Tech. Suitable display devices and touch screen interfaces can be obtained, for example, from Logic Supply. Although the exemplary PPK computing hardware environment 101 is shown as including a magnetic card reader 106, certain embodiments of the disclosed technology is meant to provide the user with an alternative to this device as a method of making payment. As shown in FIG. 1, the PPK computing hardware environment 101 is coupled to the back office server environment 120 via the network 130 (e.g., the internet, a wide-area network, a local-area network, a Wi-Fi network, a client-server network, a wireless mesh network, or other such network or any combination thereof). In particular embodiments, the back office server environment 120 is implemented as part of a cloud-based back office server.

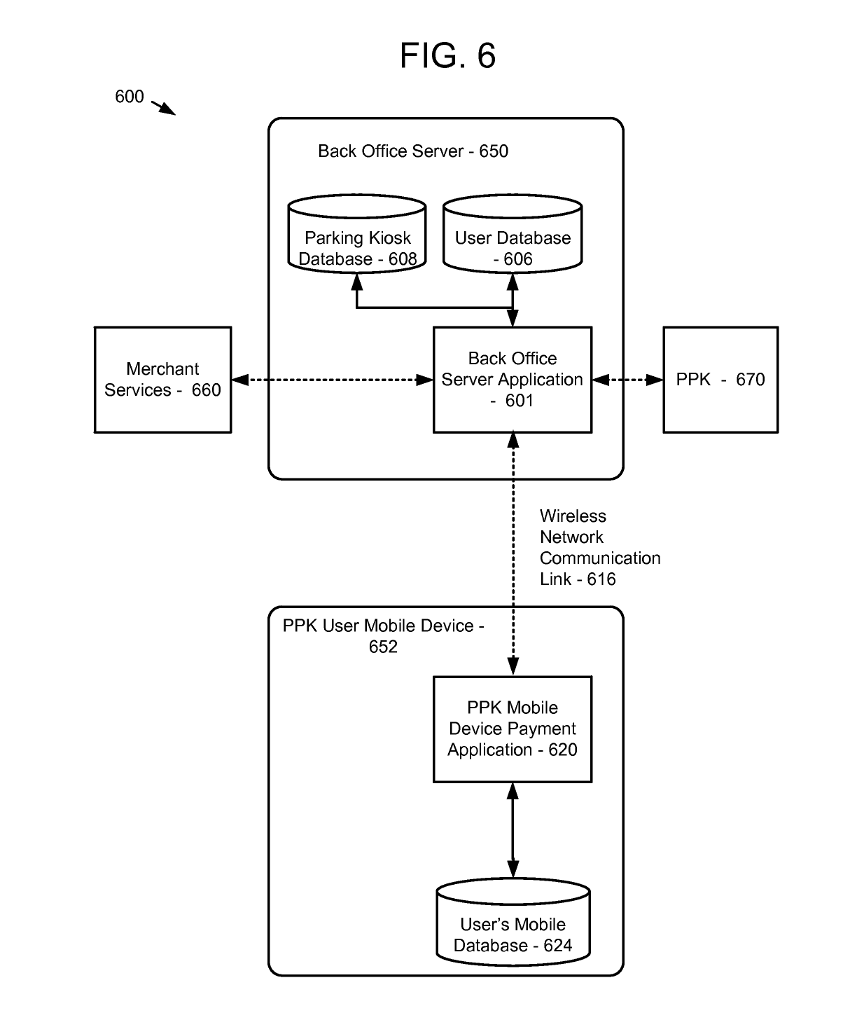

In operation, the PPK computing hardware environment 101 can create a number of data packets or messages that are transmitted to the back office server environment 120 via a network 130. The back office server environment 120 can receive these packets or messages and can also create data packets or messages that will be transmitted to the PPK computing hardware environment 101 via the network 130. An exemplary method and system for communicating between the PPK computing hardware environment 101 and the back office server environment 120 is described below in connection with FIG. 6.

Returning to FIG. 1, the back office server environment 120 can be implemented using a wide variety of computers and/or servers (e.g., a suitable commercially available server or cloud-based server). In FIG. 1, the back office server environment 120 includes back office server software 124, which can comprise computer-executable instructions stored on non-transitory computer-readable media (e.g., any one or more of the non-transitory computer-readable media described above). When executed, the software can be used to implement the functionality of the back office server, which is described in more detail below. The back office server 120 further comprises a back office server processor 122 for executing software 124. Also shown in FIG. 1 is user data 130. The user data 130 can comprise data stored on non-transitory computer-readable media that is related to parking users of parking spaces or users of a parking facility or parking facility operator associated with the PPK. For example, the data can include data about a user's identification, address, account credit balance, account history, vehicle, and/or other such user data.

In the illustrated embodiment, the back office server 120 also includes data 126 for implementing one or more web pages for a parking facility operator. The web page data 126 can comprise data stored on non-transitory computer-readable media that is used to render or otherwise implement one or more web pages for display to a parking facility operator. The web pages can be displayed, for example, using a suitable internet browser or media player implemented at a computer operated by the parking facility operator and coupled to the back office server 120 via a network (e.g., the internet, a wide-area network, a local-area network, a Wi-Fi network, a client-server network, a wireless mesh network, or other such network or any combination thereof). The web page data can be in any format or language suitable for implementing web pages (e.g., HTML, Flash, Java, and the like). In other embodiments, the data to be displayed to the parking facility operator is not stored as web page data, but as data usable via a non-web-based user interface (e.g., a dedicated program that directly interfaces with the back office server 120).

The back office server 120 can also include data 128 for implementing one or more web pages for a user (e.g., a parking customer). The web page data 128 can comprise data stored on non-transitory computer-readable media that is used to render or otherwise implement one or more web pages for display to a user. The web pages can be displayed, for example, using a suitable internet browser or media player implemented at a computer (e.g., a mobile device) operated by the user and coupled to the back office server 120 via a network (e.g., the internet, a wireless network, wide-area network, a local-area network, a Wi-Fi network, a client-server network, a wireless mesh network, or other such network or any combination thereof). The web page data can be in any format or language suitable for implementing web pages (e.g., HTML, Flash, Java, and the like). In other embodiments, the data to be displayed to the PPK user is not stored as web page data, but as data usable via a non-web-based user interface (e.g., a dedicated program that directly interfaces with the back office server 120). Further, although the data 128 is shown as being stored at the back office server 120, at least some of data 128 can alternatively be stored at another server that interoperates with the back office server 120 (e.g., a website hosting server or a cloud-based server). In this regard, at least some of the data 126 may also be stored at such a server. In certain embodiments, the web page data 128 is data for implementing web pages that show the user information about the state of the user's account, including amount of credit balance and purchase history. For example, the web page data can include data for implementing a log-in screen, through which the user can provide personal information and associate a credit/debit card or bank account with their account controlled by the back office server 120, and data for implementing an account status screen, through which the user is presented a graphical or numerical indication of the state of the user's account. The back office server software 124 can include machine instructions that when executed by a processor enable the server to receive information about the identity of the user at the log-in screen, match the identity to a user in a user database, and cause the display of the information about the state of the user's account via one or more web pages displayed to the user. The information about the user's account can comprise, for instance, the current credit balance in the account, the method of payment (e.g., credit/debit card or bank account information) to be used for parking payment purposes, and a record of past charges against this account.

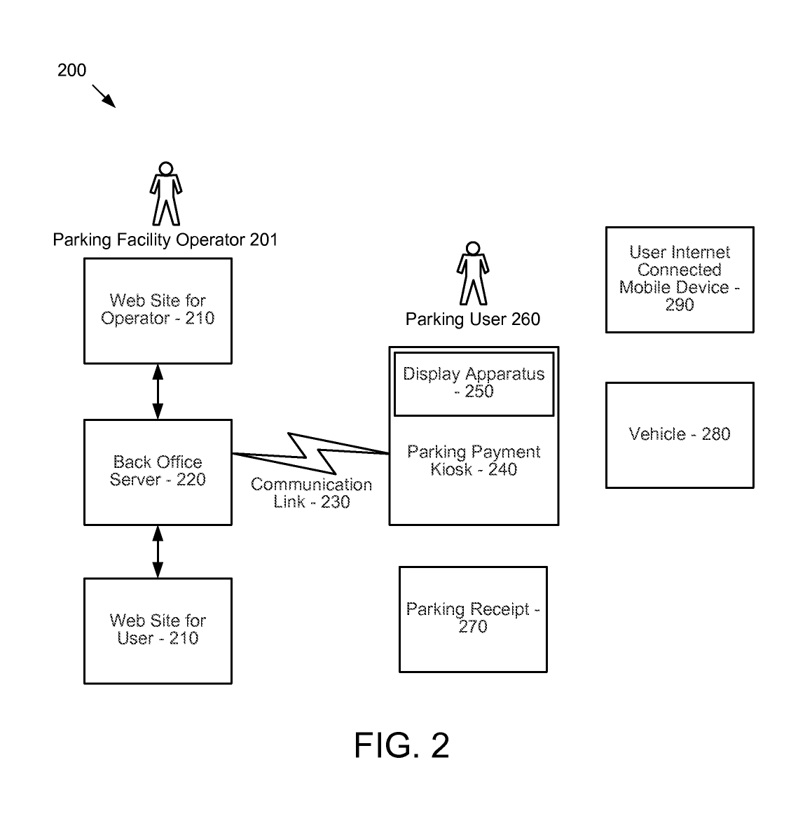

FIG. 2 is a schematic block diagram 200 illustrating an exemplary PPK mobile device payment system and the users of the exemplary system. In FIG. 2, a user 260 interfaces with a PPK 240 using a display apparatus 250. The display apparatus 250 allows the user to view operating instructions and/or to make entries of information. As noted above, the functionality of the display apparatus 250 can be implemented by executing appropriate software stored at the PPK (e.g., PPK software 102). The PPK 240 uses a communication device (e.g., one or more of the wireless radio 104 or Ethernet connection 108 shown in FIG. 1 or other such network communication device, such as a cellular transceiver) to establish a communication link 230 with a back office server 220. The functionality of the back office server 220 can be implemented by executing appropriate back office software stored at the back office server 220 (e.g., back office server software 124). The PPK 240 also uses the communication device to transmit information entered by the user 260 to the back office server 220. This information can comprise, for example, entries made by the user via the display apparatus 250.

In embodiments of the disclosed technology, the display apparatus 250 displays information that can be used by a mobile device operated by the user. For example, in certain embodiments, the display apparatus 250 is used to display a quick reference (“QR”) code, a barcode (linear or two-dimensional), or an alpha-numeric code that can then be scanned with an internet-connected mobile device 290 operated by the PPK user 260. Furthermore, and as more fully explained below with respect to FIG. 6, the mobile device 290 can be configured to communicate with the back office server 220 (e.g., via a cellular or other wireless network link, shown as network communication link bro in FIG. 6).

FIG. 6 is a schematic block diagram illustrating components of an exemplary mobile device 652 (which can correspond to the mobile device 290 in FIG. 2) and a PPK back office server 650 (which can correspond to the back office server 220 in FIG. 2) with which the mobile device 652 can communicate. In the illustrated embodiment, the mobile device 652 includes a PPK Mobile Payment Application (“MPA”) 620 configured to communicate with a back office server application 601 (which can be part of the software 124 shown in FIG. 1) running on the back office server 650 (e.g., via the internet). The MPA 620 accesses the user's database 624 that is stored locally on the mobile device 652 (although in other embodiments, the database is stored remotely, such as in a cloud-based server). In the illustrated embodiment, the user's database 624 is a local copy of some or all of the user's account data that is stored on the back office server. The MPA 620 and the back office server application 601 can periodically synchronize these two databases. The MPA 620 can implement a “scanning” operation on the mobile device that scans the QR code, barcode, or alpha-numeric code that is shown on the display apparatus of PPK 670 (such as PPK 240 in IFG. 2) (e.g., using the mobile device's camera (such as the mobile device's image sensor) and suitable software for capturing an image of the code and decoding the code) and transmits the decoded data embedded in this code, combined with the vehicle identification, and the user's identity information from the mobile database 624 to the back office server application 601 via the network communication link 616. The data embedded in the code can include one or more of a unique identification of the PPK 670 that the user is using, the pricing information for the parking facility or area controlled by this PPK and/or other information that will be used by the back office server application 601 to properly determine the costs to bill the user for this parking session. For certain parking facilities, the user will also use the MPA to indicate the amount of time that they wish to pay for and this information will also be included in the data packet that is sent to the back office 650. Once this data and the user identification information is received by the back office server 650, the back office server application, either independently or by interfacing with a remote merchant services 660, can process the user's payment. If the user's payment is authorized, the back office server 650 transmits authorization information to the user's mobile device 652 so that the MPA 620 can update the user's mobile database 624 and display a message to the user that their parking has been authorized and for some parking facilities, when the parking session will expire. In certain embodiments, and when parking is authorized for a fixed amount of time, the MPA can provide an alert (visual and/or audio alert) to the user when the parking session is close to expiration (e.g., within a set time of expiring, such as within 15 minutes, 10 minutes, 5 minutes or any other time between these numbers and expiration, or within a user-selected time period or other number of minutes). Further, the MPA can then prompt the user as to whether additional parking time is desired, in which case data requesting the desired additional time can be sent to the back office server to seek authorization for the additional time.

The back office server 220 in FIG. 2 is also configured to operate a website 210 for exchanging information relative to the PPKs with the user 260. The information can comprise, for example, the current status of the user's account, account records for the user, or other such information. The user 260 can use this website to increase the credit balance on their account and manage payment sources (e.g., link the account to a bank account or credit/debit card). As noted, another server can also be used to operate the website 210.

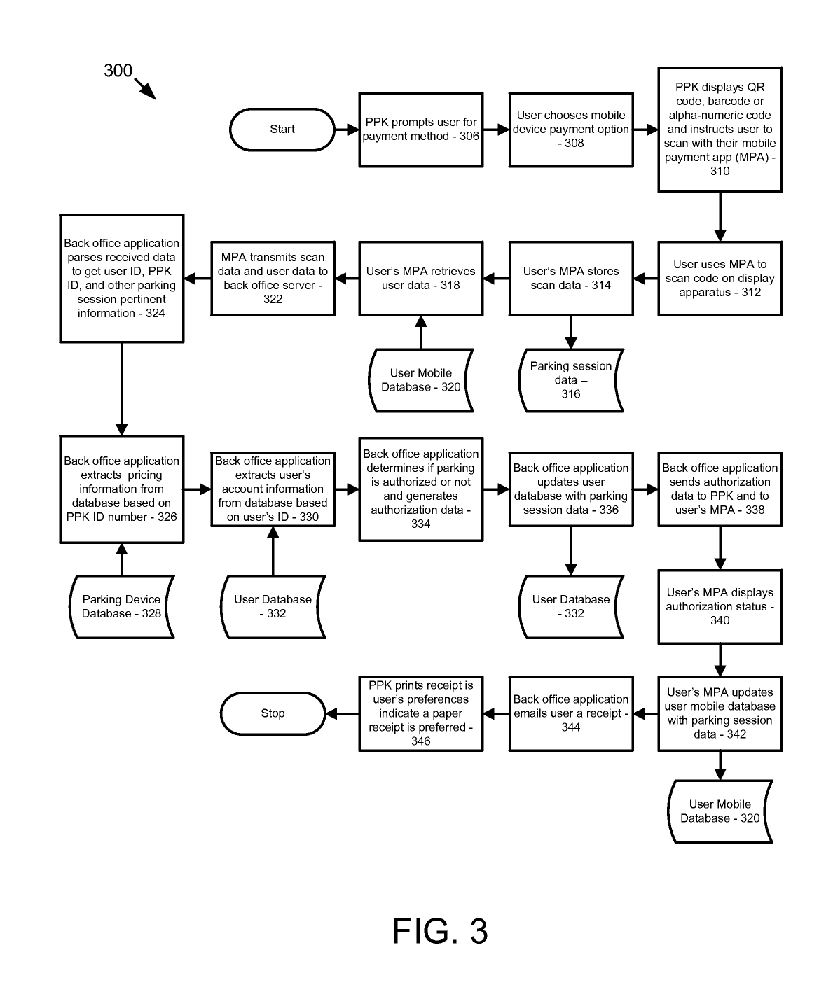

FIG. 3 is a flow chart 300 showing an exemplary process for processing payment for use of a PPK using the disclosed technology. As noted above, the functionality shown in FIG. 3 can be implemented by computing hardware executing computer-executable instructions. The various procedures shown in FIG. 3 should not be construed as limiting, as any one or more of the procedures can be performed alone or in various other combinations and subcombinations in accordance with the disclosed technology.

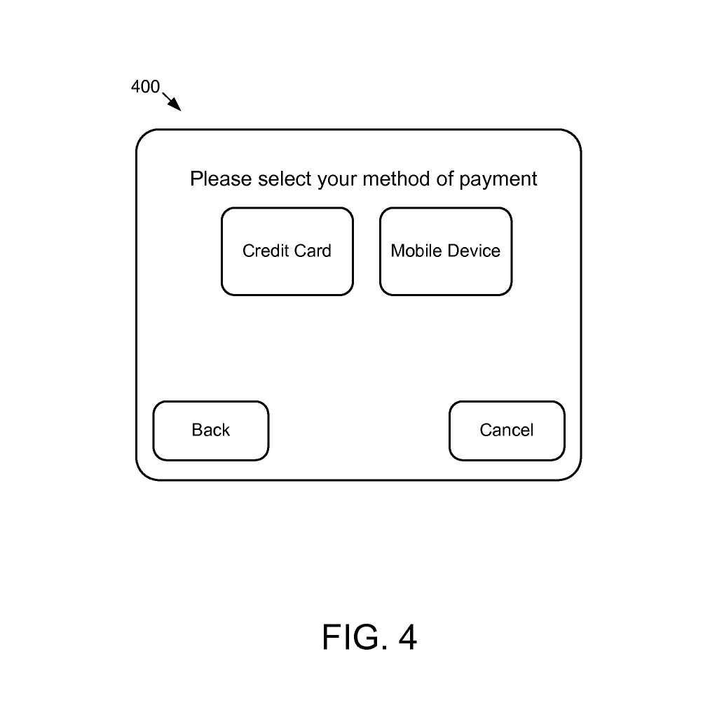

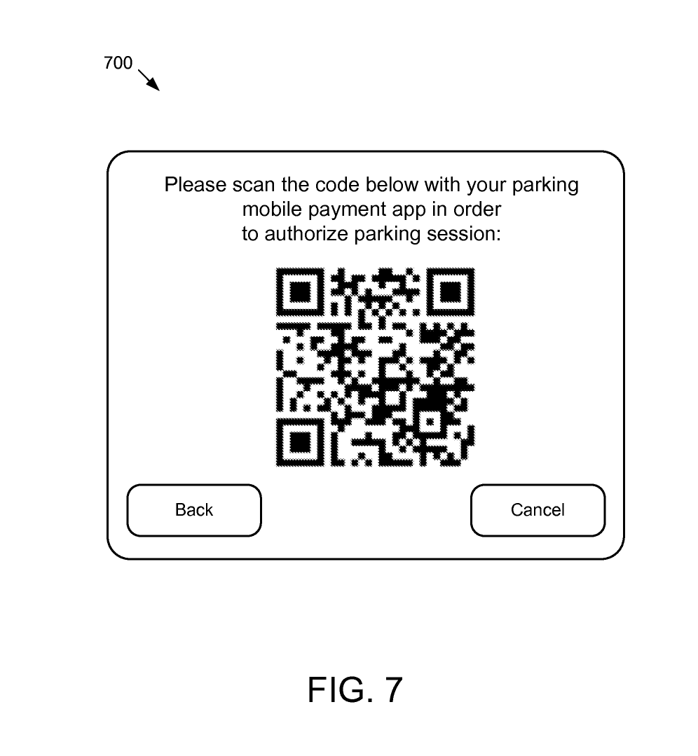

In particular embodiments, the PPK will first prompt the user to select their payment method of access method (process block 306). FIG. 4 shows a representative PPK display screen 400 in which the user is prompted to select their method of payment. When the user selects the mobile device payment option (process block 308), the PPK display apparatus displays a QR code, barcode, alphanumeric or some other code and instructs the user to use their MPA to scan this code (process block 310). The PPK will generate this code based on the PPK's unique identification (ID) number, the current date/time, a unique parking session ID number, the pricing information for this station, and/or other data that may be used to for proper billing of a parking session. FIG. 7 illustrates an exemplary EVCS/EVSE screen showing a possible screen for presenting the user with a QR code to be scanned by the user in order to authorize a parking session.

The user will login to MPA on their mobile device and use the MPA to scan the code displayed by the PPK (process block 312). The MPA will store the pertinent data contained in the scanned code (process blocks 314 & 316) and retrieve the user's account data, including their ID and vehicle identification, from, for example, a mobile user database stored on the mobile device (by the MPA) (process blocks 318 & 320). The MPA will then build a message that includes the user's and vehicle's identification data and the data from the scanned code and send this message to the back office application running on the back office server (process block 322).

Once the back office application receives the message from the PPK, it will parse this message to retrieve the user's unique ID number, the user's vehicle identification, the PPK's unique ID number, the parking session start date/time, session ID and/or other information that may be included in the message to ensure the correct payment for the parking session (process block 324). The back office server has a database of each installed PPK (608 in FIG. 6) and the back office application will use the PPK's unique ID number from the message to retrieve the PPK's pricing information, and/or any other data that may be used to ensure correct pricing of the parking session and, for some parking facilities, that the user has selected an allowable amount of time to park for (process block 326 & 328). The back office application will also retrieve the user's account information from the user database based on the user's unique ID number (process block 330 & 332). Based on the pricing data and the user's account data, the back office application will attempt to authorize payment for this particular parking session (process block 334). This determination may include, but is not limited to, activities such as debiting the user's account credit balance and/or interfacing with a third-party merchant services or other credit/debit card processing service to enter a charge on their account. If the user has an insufficient credit balance in their account, the back office application can also allow for them to set account preferences which instruct the back office application to debit their credit card for a fixed amount when their account's credit balance falls below a minimum level, thereby ensuring that as long as a valid credit/debit card and/or other banking information is associated with the account, there will always be sufficient funds in the account to cover parking sessions.

Once the back office application has processed the transaction for the parking session, it will construct a message with the authorization data and update the user's database with this session's authorization data (process blocks 332 & 336). The back office application will then transmit this authorization message to both the parking enforcement's mobile device and the MPA on the user's mobile device (process block 338). When the user's MPA receives the authorization message it will display the authorization result and other pertinent information to the user (process block 340). The MPA will update the user's database on the user's mobile device with the information from this particular authorization (process block 342, 320).

Although not shown in this figure, parking enforcement personnel can also use a mobile device to display a list of vehicle identifications (e.g., license plate numbers) that are authorized for parking at any given moment in time and compare those identifications against the vehicles actually parked in the facility.

The user can elect to have receipts emailed to them from the back office application (process block 344). Or if desired, the PPK can be configured to print a receipt once the transaction is authorized (process block 346) but this typically requires the user to remain at the PPK while the transaction is processed, so it may not be desirable to print receipts in many usage scenarios.

While not shown in the flowchart in FIG. 3, the disclosed technology is also applicable to usage scenarios where the time that the user will park is not known at the time the user initiates the parking session. For these scenarios, the parking session data is stored on the user's database, and the user can scan another code displayed by a device at the parking facility upon completion of the parking session (e.g., a device at an exit location in the parking facility). This other code can be a code that signifies the end of any parking session and can include a current time. Upon receiving this scan, the user's MPA will send the data from this scan, and the parking session data from the user's database on their mobile device to the back office server to complete the transaction. Once the back office has completed the transaction, the back office will send an authorization code to the user's MPA and the device at the parking facility exit, and the device at the parking facility exit will allow the user to leave the facility (e.g., open the exit gate).

As noted, the disclosed technology can also be used to allow a user to purchase additional parking time using the MPA resident in their internet-connected mobile device if the parking facility allows it.

### III. Further Embodiments

Having described and illustrated the principles of the disclosed technology in the detailed description and accompanying drawings, it will be recognized that the various embodiments can be modified in arrangement and detail without departing from such principles. Furthermore, any features or aspects of the disclosed embodiments can be used in various combinations and subcombinations with one another.

Furthermore, it is to be understood that any of the features and embodiments described herein can be used in combination with any of the features and embodiments described in U.S. Provisional Application No. 61/694,647, filed on Aug. 29, 2012, and entitled “ELECTRIC VEHICLE CHARGING STATION MOBILE DEVICE PAYMENT SYSTEM”; U.S. Nonprovisional application Ser. No. 14/014,108, filed on Aug. 29, 2013 and entitled “ELECTRIC VEHICLE CHARGING STATION MOBILE DEVICE PAYMENT SYSTEM”; U.S. Provisional Application No. 61/719,483, filed on Oct. 28, 2012, and entitled “SYSTEM FOR COMBINING PAYMENT FOR ELECTRIC VEHICLE CHARGING AND PARKING”; and U.S. Provisional Application No. 71/728,134, filed on Nov. 19, 2012, and entitled “RESERVATION SYSTEMS FOR ELECTRIC VEHICLE CHARGING STATIONS”, all of which are hereby incorporated herein by reference.

Furthermore, it is to be understood that any of the features and embodiments described herein can be used in combination with any of the features and embodiments described in U.S. Provisional Application No. 61/307,318, filed on Feb. 23, 2010, and entitled “ELECTRIC VEHICLE CHARGING STATION WITH TOUCH SCREEN USER INTERFACE”; U.S. Provisional Application No. 61/409,108, filed on Nov. 1, 2010, and entitled “ELECTRIC VEHICLE CHARGING STATION WITH TOUCH SCREEN USER INTERFACE”; U.S. Provisional Application No. 61/307,377, filed on Feb. 23, 2010, and entitled “ELECTRIC VEHICLE CHARGING STATION ADVERTISING SYSTEM”; U.S. Provisional Application No. 61/353,944, filed on Jun. 11, 2010, and entitled “ELECTRIC VEHICLE CHARGING STATION ADVERTISING SYSTEM”; U.S. Provisional Application No. 61/317,181, filed on Mar. 24, 2010, and entitled “ELECTRIC VEHICLE CHARGING STATION PARKING METER SYSTEM”; U.S. Nonprovisional application Ser. No. 12/954,209, filed on Nov. 24, 2010, and entitled “ELECTRIC VEHICLE CHARGING STATION ADVERTISING SYSTEMS” (published as U.S. Patent Application Publication No. 2011/0204847), U.S. Nonprovisional application Ser. No. 13/033,179, filed on Feb. 23, 2011, and entitled “ELECTRIC VEHICLE CHARGING STATIONS WITH TOUCH SCREEN USER INTERFACE” (published as U.S. Patent Application Publication No. 2011/0213656), and U.S. Nonprovisional application Ser. No. 13/070,389, filed on Mar. 23, 2011, and entitled “ELECTRIC VEHICLE CHARGING STATION PARKING METER SYSTEMS” (published as U.S. Patent Application Publication No. 20110239116), all of which are hereby incorporated herein by reference.

In view of the many possible embodiments to which the principles of the disclosed invention may be applied, it should be recognized that the illustrated embodiments are only preferred examples of the invention and should not be taken as limiting the scope of the invention. Rather, the scope of the invention is defined by the following claims and their equivalents. I therefore claim as my invention all that comes within the scope and spirit of these claims and their equivalents.

What is claimed is:

1. A method performed by a mobile device, the method comprising:
reading encoded parking session data that is being displayed on a display apparatus of a parking payment kiosk;
decoding the encoded parking session data;
transmitting the decoded parking session data along with one or more of user identification data or vehicle data to a remote server; and
receiving a response from the remote server, the response indicating whether a parking session at a location controlled by the PPK is authorized.

2. The method of claim 1, wherein the parking session data is encoded in a QR code, barcode, or alphanumeric code.

3. The method of claim 1, wherein the response indicates that parking is authorized even though a total cost of the parking is not yet known.

4. The method of claim 1, wherein the encoded parking session data comprises first encoded parking session data, the method further comprising:
reading second encoded parking session data;
decoding the second encoded parking session data;
transmitting the second encoded parking session data along with one or more of the user identification data or the vehicle data to the remote server; and
receiving a response from the remote server indicating a final cost for the parking session.

5. The method of claim 1, wherein the vehicle data comprises a license plate number for a vehicle.

6. The method of claim 1, further comprising notifying the user that the parking session will expire in a set amount of time; and allowing the user to add additional time to the parking session.

7. A method performed by computing hardware, comprising:
receiving data transmitted from a mobile device, the data comprising parking session data indicating at least an identity of a parking payment kiosk and one or more of user identification data or vehicle data, the user identification data indicating at least an identity of a user at the parking payment kiosk (“PPK”), the vehicle data indicating an identity of a vehicle associated with the user;
determining whether to authorize a parking session at the PPK for the user, wherein the determining is based at least in part on the received data; and
transmitting an indication of whether the parking session is authorized to the mobile device.

8. The method of claim 7, further comprising transmitting the indication of whether the parking session is authorized to the PPK.

9. The method of claim 7, further comprising transmitting the indication of whether the parking session is authorized to one or more computing devices operated by enforcement personnel associated with the PPK.

10. The method of claim 7, determining a final cost for parking at a time subsequent to the authorization of the parking.

11. The method of claim 7, wherein the data further indicates a desired length of time for parking.

12. The method of claim 7, wherein the data is first data, wherein the first data does not include a desired length of time for parking, and wherein the method further comprises:
receiving second data transmitted from the mobile device, the second data indicating an end of the parking session initiated by the first data; and
computing a final cost of the parking session after receipt of the second data.

13. A method performed by hardware in a parking payment kiosk (“PPK”), the method comprising:
displaying encoded parking session data on a display device of the PPK; and
receiving an indication from a remote computer of whether parking at a location controlled by the PPK and associated with the encoded parking session data is authorized.

14. The method of claim 13, wherein the displaying is prompted by a user selecting to use a payment method that involves the use of a mobile device.

15. A system, comprising:
a parking payment kiosk (“PPK”) comprising a display apparatus and computing hardware, the computing hardware being programmed to display encoded parking session data on the display apparatus;
non-transitory computer-readable media storing processor-executable instructions for a mobile payment application (“MPA”), which when executed by a processor in a mobile device cause the mobile device to: (a) read and decode the encoded parking session data on the PPK display apparatus, (b) create a dataset comprising the parking session data, user identification data, and vehicle data, and (c) transmit the dataset; and
a server comprising computing hardware programmed to process payment for a parking session based on the dataset and to notify a user whose mobile device transmitted the dataset that payment has been processed and that parking is authorized, the notification being performed via the MPA on the user's mobile device.

16. The system of claim 15, wherein the server processes payment for the parking session by:
receiving the user's identification data and the parking session data;
accessing user data stored at the server; and
determining whether the user is authorized to park based on the user data.

17. The system of claim 15, wherein the PPK is further programmed to display on the display apparatus of the PPK graphical depictions of two or more available methods of authorizing parking.

18. The system of claim 17, wherein one of the available methods of authorizing parking comprises authorization through use of the MPA on the user's mobile device.

19. The system of claim 15, wherein the MPA further includes instructions, which when executed by a processor, provide an alert to the user when the parking session is close to expiration and allows the user to purchase more time by using the application.

20. A parking payment kiosk (“PPK”) comprising:
a display apparatus; and
a computer processor, the computer processor being programmed to cause a unique parking session code to be displayed on the display apparatus upon a user requesting a parking session but before authorization of the parking session, the unique parking session code being displayed as a two-dimensional barcode.
